(19) United States
(12) Patent Application Publication
(10) Pub. No.: US 2017/0277474 A1
(43) Pub. Date: Sep. 28, 2017

(54) DATA PROCESSING SYSTEM INCLUDING DATA STORAGE DEVICE

(71) Applicant: SK hynix Inc., Gyeonggi-do (KR)

(72) Inventor: Beom Ju SHIN, Gyeonggi-do (KR)

(21) Appl. No.: 15/217,286

(22) Filed: Jul. 22, 2016

(30) Foreign Application Priority Data
Mar. 24, 2016 (KR) 10-2016-0035038

(51) Int. Cl. G06F 3/06; G06F 12/10

(52) U.S. Cl. CPC G06F 3/0659; G06F 3/061; G06F 3/0643; G06F 3/065; G06F 3/0673; G06F 12/10; G06F 2212/65

(57) ABSTRACT

A data processing system includes a data storage device; and a host device configured to transmit a write request to the data storage device to store data in the data storage device, wherein the host device transmits the write request including a request purpose meaning what a cause that results in the write request is, and wherein the data storage device processes the write request based on the request purpose.

### CROSS-REFERENCES TO RELATED APPLICATION

The present application claims priority under 35 U.S.C. §119(a) to Korean application number 10-2016-0035038, filed on Mar. 24, 2016, in the Korean Intellectual Property Office, which is incorporated herein by reference in its entirety.

### BACKGROUND

1. Technical Field

Various embodiments generally relate to a data processing system including a data storage device which stores data to be accessed by a host device.

2. Related Art

Recently, the paradigm for the computer environment has been converted into ubiquitous computing so that computer systems can be used anytime and anywhere. Due to this, use of portable electronic devices such as, for example, mobile phones, digital cameras, and notebook computers has rapidly increased. In general, such portable electronic devices use a data storage device which uses a memory device. A data storage device is used to store data to be used in a portable electronic device.

A data storage device using a memory device provides advantages in that, since there is no mechanical driving part, stability and durability are excellent, an information access speed is high and power consumption is small. Data storage devices having such advantages include a universal serial bus (USB) memory device, memory cards having various interfaces, a universal flash storage (UFS) device, and a solid state drive (SSD).

### SUMMARY

Various embodiments are directed to a data storage device capable of minimizing operations of writing data in a storage medium,

Various embodiments are directed to a data storage device capable of processing a request of a host device only by changing an address mapping information.

In an embodiment, a data processing system may include: a data storage device; and a host device configured to transmit a write request to the data storage device to store data in the data storage device, wherein the host device transmits the write request including a request purpose meaning what a cause that results in the write request is, and wherein the data storage device processes the write request based on the request purpose.

In an embodiment, a data processing system may include: a data storage device; and a host device configured to transmit a write request according to a transmission protocol with respect to the data storage device, to the data storage device, to store data in the data storage device, wherein the host device transmits the write request including a request purpose meaning what a cause that results in the write request is, and wherein the data storage device processes the write request based on the request purpose.

According to the embodiments, since it is possible to process a request of a host device only by changing an address mapping information, a data storage device may minimize operations of writing data in a storage medium.

### BRIEF DESCRIPTION OF THE DRAWINGS

FIG. 1 is a block diagram illustrating a data processing system, according to an embodiment of the invention.

FIG. 2 is a diagram illustrating exemplary requests transmitted from a host device to a data storage device, according to an embodiment of the invention.

FIG. 3 is a diagram illustrating n address, map, according to an embodiment of the invention.

FIG. 4 is a diagram illustrating a case where a write request due to a file generation is transmitted to the data storage device shown in FIG. 1, according to an embodiment of the invention.

FIG. 5 is a diagram illustrating an example of an address map of the data storage device which processes the request illustrated in FIG. 4.

FIG. 6 is a diagram illustrating a case where a write request due to a file copy is transmitted to the data storage device, according to an embodiment of the invention.

FIG. 7 is a diagram illustrating an example of an address map of the data storage device which processes the request illustrated in FIG. 6.

FIG. 8 is a diagram illustrating a case where a write request due to a file change is transmitted to the data storage device, according to an embodiment of the invention.

FIG. 9 is a diagram illustrating an example of an address map of the data storage device which processes the request illustrated in FIG. 8.

FIG. 10 is a diagram illustrating a case where an erase request due to a file erase is transmitted to the data storage device, according to an embodiment of the invention.

FIG. 11 is a diagram illustrating an example of an address map of the data storage device which processes the request illustrated in FIG. 10.

FIG. 12 is a block diagram illustrating a data processing system including a solid state drive (SSD), according to an embodiment of the invention.

FIG. 13 is a block diagram illustrating an example of the SSD controller shown in FIG. 12, according to an embodiment of the invention.

FIG. 14 is a block diagram illustrating a computer system including a data storage device, according to an embodiment of the invention.

### DETAILED DESCRIPTION

In the present invention, advantages, features and methods for achieving them will become more apparent after a reading of the following embodiments taken in conjunction with the drawings. The present invention may, however, be embodied in different forms and should not be construed as being limited to the embodiments set forth herein. Rather, these embodiments are provided to describe the present invention in sufficient detail to the extent that a person skilled in the art to which the invention pertains can practice the present invention.

It is to be understood herein that embodiments of the present invention are not limited to the particulars shown in the drawings and that the drawings are not necessarily to scale and in some instances proportions may have been exaggerated in'order to more clearly depict certain features of the invention. Whiff e particular terminology is used herein, it is to be appreciated that the terminology used herein is for the purpose of describing particular embodiments only and is not intended to limit the scope of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms as well,unless the context clearly indicates otherwise. It will be further understood that the terms “includes,” “including,” “comprises,” and/or “comprising” when used in this specification, specify the presence of at least one stated feature, step, operation, and/or element, but do not preclude the presence or addition of one or more other features, steps, operations, and/or elements thereof.

Hereinafter, a data processing system including a data storage device will be described below with reference to the accompanying drawings through various embodiments.

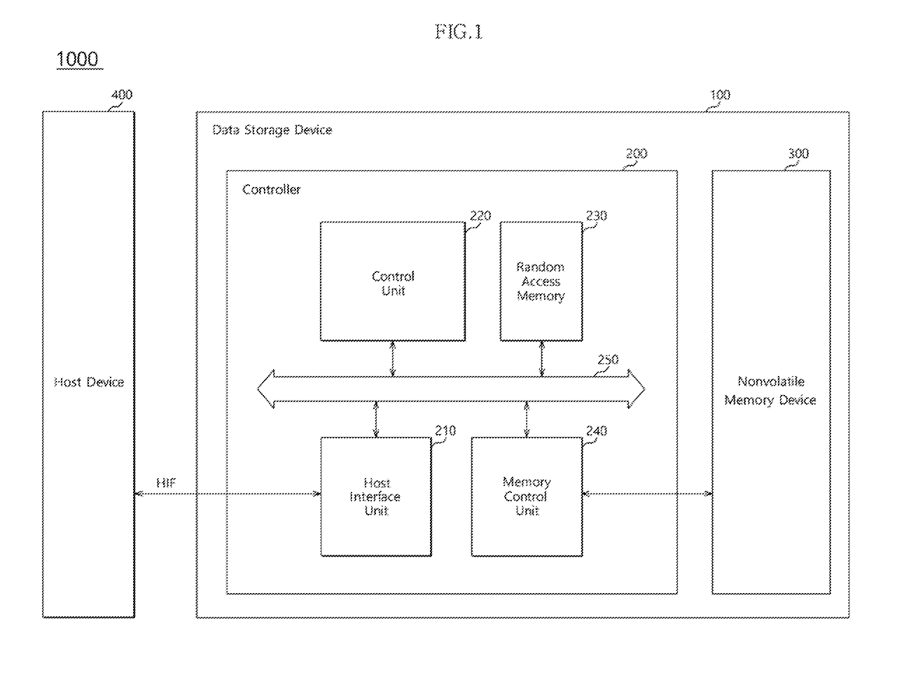

FIG. 1 illustrates a data processing system 1000, according to an embodiment of the invention.

The data processing system 1000, according to the embodiment of FIG. 1, may include a data storage device 100 and a host device 400. The data storage device 100 may store data to be accessed by the host device 400, such as a mobile phone, an MP3 player, a laptop computer, a desktop computer, a game player, a TV, an in-vehicle infotainment system, and the like. The data storage device 100 may also be referred to as a memory system,

The data storage device 100 may be manufactured as any one among various storage devices according to a host interface HIF transmission protocol for communicating with the host device 400. For example, the data storage device 100 may be configured as any one of various storage devices, such as a solid state drive, a multimedia card in the form of an MMC, an eMMC, an RS-MMC and a micro-MMC, a secure digital card in the form of an SD, a mini-SD and a micro-SD, a universal serial bus (USB) storage device, a universal flash storage (UFS) device, a Personal Computer Memory Card International Association (PCMCIA) card type storage device, a peripheral component interconnection (PCI) card type storage device, a PCI express (PCI-E) card type storage device, a compact flash (CF) card, a smart media card, a memory stick, and the like.

The data storage device 100 may be manufactured as any one among various packages, such as a package-on-package (POP), a system-in-package (SIP), a system-on-chip (SOC), a multi-chip package (MCP), a chip-on-board (COB), a wafer-level fabricated package (WFP) and a wafer-level stack package (WSP).

The data storage device 100 may include a controller 200 and a nonvolatile memory device 300.

The nonvolatile memory device 300 may operate as the storage medium of the data storage device 100 The nonvolatile memory device 300 may be configured by any one of various nonvolatile memory devices, such as a NAND flash memory device, a NOR flash memory device, a ferroelectric random access memory (FRAM) using a ferroelectric capacitor, a magnetic random access memory (MRAM) using a tunneling magneto-resistive (TMR) layer, a phase change random access memory (PCRAM) using a chalcogenide alloy, and a resistive random access memory (RERAN) using a transition metal oxide. The ferroelectric random access memory (FRAM), the magnetic random access memory (MRAM), the phase change random access memory (PCRAM) and the resistive random access memory (RERAM) are examples of nonvolatile random access memory devices capable of random access to memory cells. In an embodiment, the nonvolatile memory device 300 may be configured by a combination of a NAND flash memory device and the above-described various types of nonvolatile random access memory devices.

The controller 200 may include a host interface unit 210, a control unit 220, a random access memory 230, and a memory control unit 240 operatively connected via a communication bus 250.

The host interface unit 210 may interface the host device 400 and the data storage device 100. For example, the host interface unit 210 may communicate with the host device 400 by using any one among standard transmission protocols such as, for example, universal serial bus (USB), universal flash storage (UFS), multimedia card (MMC), parallel advanced technology attachment (PATA), serial advanced technology attachment (SATA), small computer system interface (SCSI), serial attached SCSI (SAS), peripheral component interconnection (PCI) and PCI express (PCI-E) protocols.

The control unit 220 may control general operations of the controller 200. The control unit 220 may drive an instruction or an algorithm of a code type, that is, a software, loaded in the random access memory 230, and may control operations of function blocks in the controller 200. The control unit 220 may analyze and process a request of the host device 400 transmitted through the host interface unit 210.

The random access memory 230 may store a software to be driven by the control unit 220. The random access memory 230 may also store data necessary for driving of the software. The random access memory 230 may operate as the working memory of the control unit 220.

The random access memory 230 may temporarily store data to be transmitted from the host device 400 to the nonvolatile memory device 300 or from the nonvolatile memory device 300 to the host device 400. In other words, the random access memory 230 may operate as a data buffer memory or a data cache memory.

The random access memory 230 may be configured by a volatile memory device, such as a DRAM or an SRAM.

The memory control unit 240 may control the nonvolatile memory device 300 according to the supervisory control of the control unit 220. The memory control unit 240 may generate control signals for controlling the operation of the nonvolatile memory device 300, for example, commands, addresses, clock signals and the like, and provide the generated control signals to the nonvolatile memory device 300. The memory control unit 240 may also be referred to as a memory interface unit.

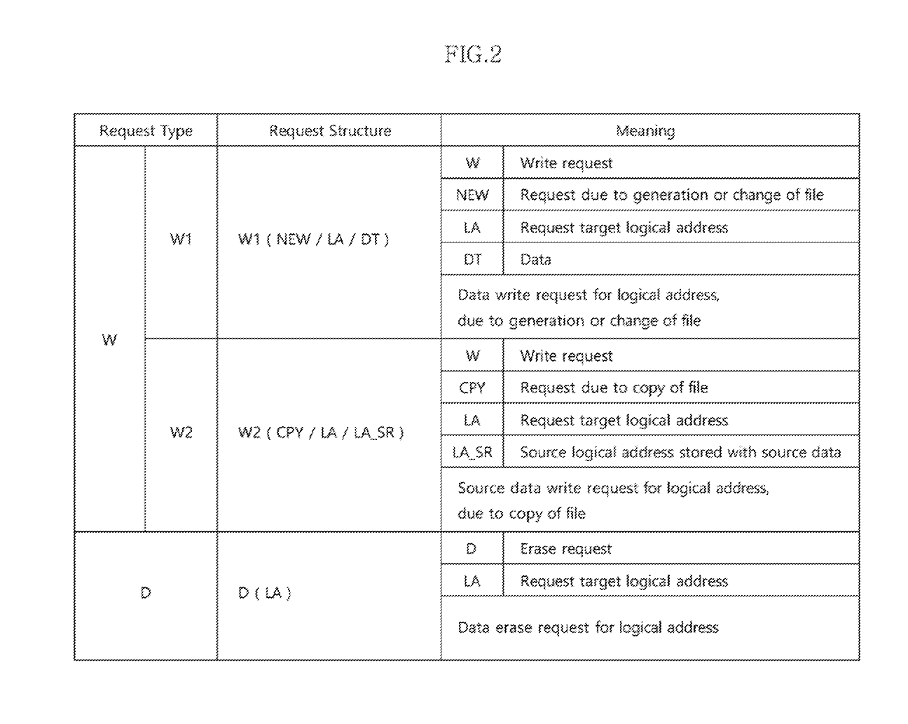

FIG. 2 illustrates examples of requests to be transmitted from the host device 400 to the data storage device 100.

The host device 400 may transmit information of a job or work to be processed by the data storage device 100, to the data storage device 100, according to the transmission protocol between the host device 400 and the data storage device 100, that is, a host interface. The information of the job or work to be processed by the data storage device 100 may be transmitted in the form of a request.

The host device 400 may transmit a write request to the data storage device 100 to store data in the data storage device 100. The write request may include cause information (also referred to as request purpose information) of the write request representing which operation causes the write request. The data storage device 100 may perform a write operation based on the request purpose information included in the write request. An example of a write operation of the data storage device 100 performed based on a request purpose information will be described below in details.

In an embodiment, a write request W may be divided into a first type write request W1 and second type write request W2 depending on the request purpose information.

The first type write request W1 may include as the request purpose information a request (denoted as “NEW” in FIG. 2) due to a file generation or a file change, a logical address (denoted as “LA” in FIG. 2) and a write data (denoted as “DT” in FIG. 2). If the first type write request W1 is transmitted from the host device 400, the data storage device 100 may determine that write of data DT for a logical address LA is requested and may determine that the write request W1 is due to a file generation or a file change (or results from a file generation or a file change).

The second type write request W2 may include as the request purpose information a request (denoted as “CRY” in FIG. 2) due to a file copy, a target logical address (denoted as “LA” in FIG. 2), and a source logical address (denoted as “LA_SR” in FIG. 2). If the second type write request W2 is transmitted from the host device 400, the data storage device 100 may determine that writing the source data for a logical address LA is requested and may determine that the write request W2 is due to a file copy (or results from file copy).

The source logical address represents the logical location of the source data to be copied while the target logical address represents the logical location where the copied data is, to be stored. The data storage device 100 may then determine the physical address of a storage area, where the source data is stored, based on the source logical address LA_SR. included in the second type write request W2.

The host device 400 may transmit an erase request D to the data storage device 100 to erase data stored in the data storage device 100. An erase request D may include a target logical address (denoted as “LA” in FIG. 2). Hence, when an erase request D is transmitted from the host device 400, the data storage device 100 may then erase the data for the requested target logical address LA.

Although only a write request W and an erase request D are described as examples with reference to FIG. 2, we note that the host device 400 may also transmit various other requests, such as, for example, a read request for reading data stored in the data storage device 100, to the data storage device 100.

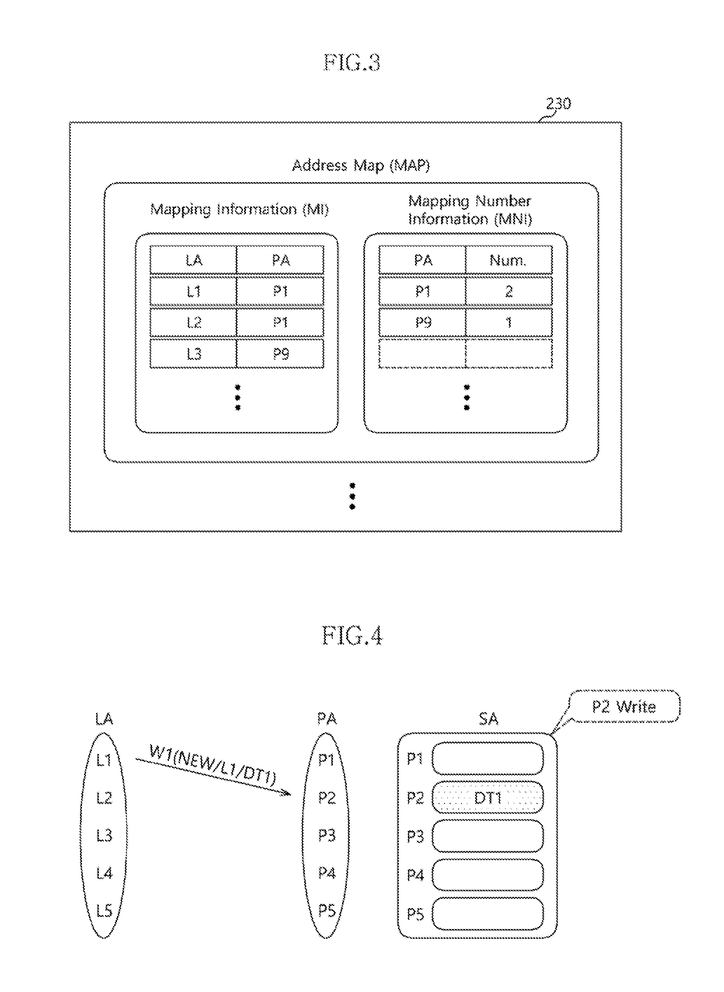

FIG. 3 illustrates an example of an address map according to an embodiment of the present invention.

In the case where the host device 400 transmits a request to the data storage device 100, the host device 400 may also provide a target logical address LA to the data storage device 100. The control unit 220 of the data storage device 100 may process the request by converting a target logical address LA into a target physical address PA denoting the position of a storage area of the la nonvolatile memory device 300. For performing such address converting operation, the control unit 220 may include an address MAP. The control unit may generate and manage the address map MAP. The address map MAP may be loaded or stored in the random access memory 230 while the data storage device 100 is in operational.

According to an embodiment, a request of the host device 400 may be processed only by updating the address map MAP even without actually writing or erasing data. For this reason, the address map MAP may include a mapping information MI and a mapping number information MNI.

The mapping information MI represents a mapping relationship between a logical address LA and a physical address PA. For example, the mapping information MI may include a plurality of logical addresses LA and a plurality of physical addresses PA corresponding to the logical addresses LA. For example, a single physical address PA may correspond to each logical address LA. Also, as an example, more than one physic& addresses may correspond to the same logical address. Two or more logical addresses LA may be mapped to the same physical address PA. For example, referring to the mapping information MI illustrated in FIG. 3, a first and second logical addresses L1 and L2 are mapped to a physical address P1, and a third logical address L3 is mapped to a physical address P9.

The mapping number information MNI includes information denoting the number of logical addresses that are mapped to a physical address PA. For instance, referring to the mapping number information MNI illustrated in FIG. 3, it may be seen that the mapping number information for P1 is two because the number of logical addresses mapped to the physical address P1 is two (that is, the logical address L1 and the logical address L2 from the MI) and the mapping number information for P9 is one because the number of logical addresses mapped to the physical address P9 is one (that is, the logical address L3).

As shown in the embodiment of FIG. 3, the mapping number information MNI may include only information about the number of logical addresses mapped to the physical addresses PA which are included in the mapping information MI, that is, physical addresses PA mapped to logical addresses LA. In another embodiment, (not shown), the mapping number information MNI may include information on all physical addresses, regardless of whether or not they are mapped to a logical addresses LA. In this case, the mapping number information of a physical address which is not mapped to a logical address LA may be “0.”

Hereinbelow, operations of the data storage device 100 processing various requests transmitted from the host device 400 (for example, operations with regard to a change of an address map MAP) and a storage area of the data storage device 100 (that is, a memory cell region of the nonvolatile memory device 300) will be described with reference to FIGS. 4 to 11.

As an example, a case in which a request is transmitted from the host device 400 for any one of five logical addresses L1 to L5 will be described. Moreover, also as an example, a case where such a request of the host device 400 is processed by using a storage area SA corresponding to five respective physical addresses P1 to P5 is described.

For example, it is assumed that various requests transmitted from the host device 400 are transmitted to process data of a file to be generated, changed or erased by a file system of the host device 400. Also, it is assumed that data of a file to be generated, changed or erased by the file system has a small size capable of being processed even by only a request for a single logical address LA. Because the data size may vary depending upon the kind of the file, various other requests may be transmitted to the data storage device 100. Even so, the various other requests may be processed in a similar manner as the operations of the data storage device 100 described below.

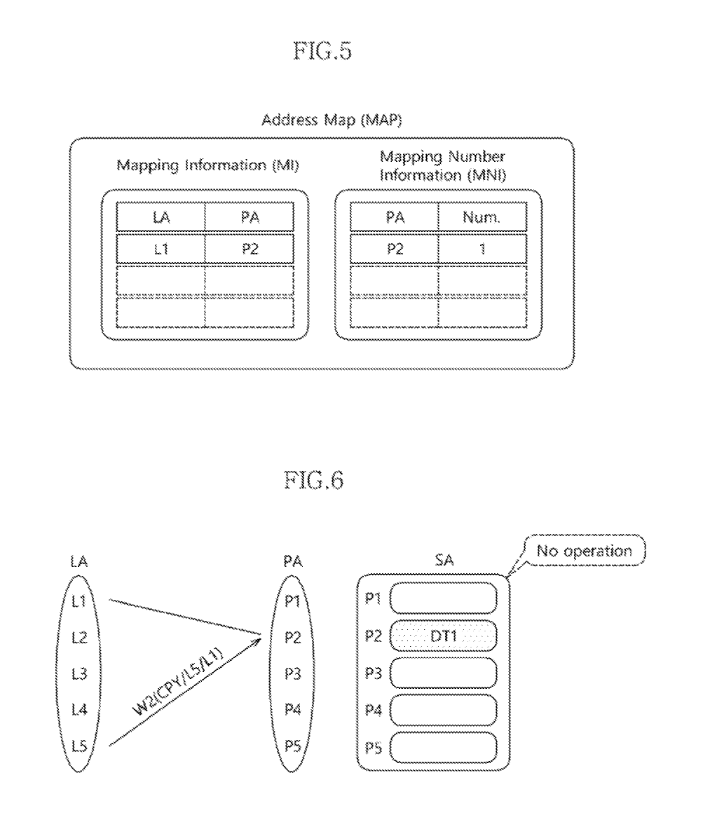

FIG. 4 illustrates a case where a write request due to a file generation is transmitted to the data storage device 100. FIG. 5 illustrates an example of an address map MAP of the data storage device 100 which processes the request illustrated in FIG. 4.

Accordingly, in the case where a new file is generated by the file system, the host device 400 may transmit the first type write request W1 to the data storage device 100. As shown in FIG. 4, the first type write request W1 may include as the request purpose information the request NEW due to a file generation, the target logical address LA, and the write data DT1 of the generated file.

The data storage device 100 may determine based on the transmitted write request Wl(NEW/L1/DT1) that writing the data DT1 for a logical address L1 is requested and that the write request is due to a file generation or a file change. Based on such a determination, the data storage device 100 may then map a physical address P2, which is not already mapped, to the logical address L1. Further, the data storage device 100 may store the data DT1 in the storage area SA corresponding to the physical address P2,

In this case, as shown in FIG. 5, the data storage device 100 may update the address map MAP to reflect the newly created mapping relationship. Hence, for the illustrated example, the mapping information MI showing the mapping relationship between the physical address P2 and the logical address L1 and the mapping number information MNI showing the number (i.e., value of “1”) of logical addresses mapped to the physical address P2 may be generated.

In the case where the first type write request W1 due to a file generation is transmitted, the data storage device 100 may process the first type write request W1 through the process of updating the address map MAP and actually storing the data DT1 in the storage area SA corresponding to the physical address P2,

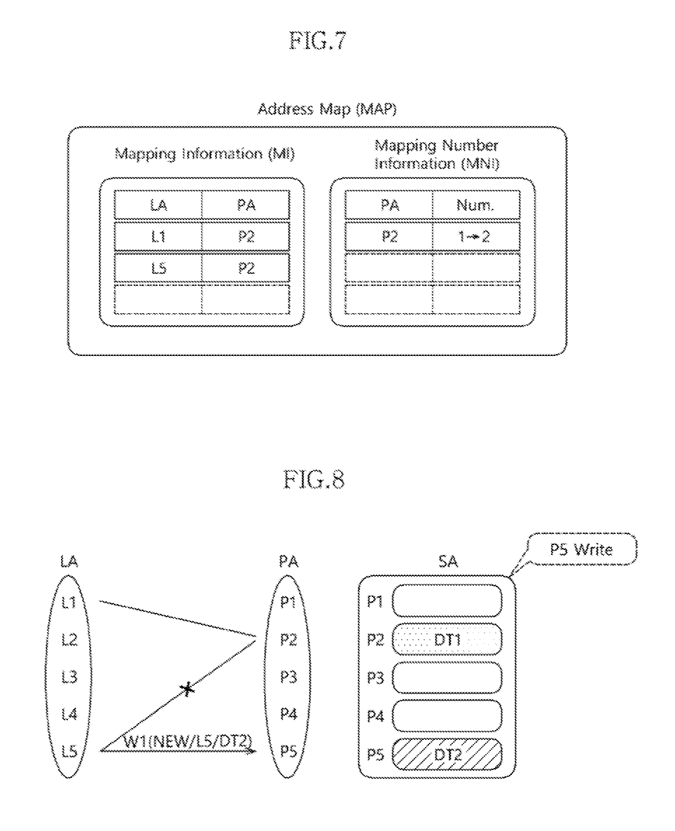

FIG. 6 illustrates a case where a write request due to a file copy is transmitted to the data storage device 100. FIG. 7 is a diagram illustrating an example of the address map MAP of the data storage device 100 which processes the request illustrated in FIG. 6. For illustration purposes an example case wherein a second type write request W2 is transmitted due to a copy of the write data DT1 of a file stored at the logical address L1 (i.e., the physical address P2) in response to the first type write request W1 (as described with reference to FIGS. 4 and 5) will be described with reference to FIGS. 6 and 7.

Accordingly, in a case where a file is copied by the file system, the host device 400 may transmit a second type write request W2 to the data storage device 100. As shown in FIG. 6, the second type write request W2 may include as the request purpose information the request CPY due to copying of the write data DT1 of the file, the target logical address L5, and the source logical address L1.

The data storage device 100 may then determine based on the transmitted write request W2(CPY/L5/L1) that writing the source data DT1, which is stored at the physical address P2 mapped to the source logical address L1, into the storage area SA of the target logical address L5 is requested and the write request is due to a file copy. Based on such a determination, the data storage device 100 may duplicately map the physical address P2 which was previously mapped to the logical address L1, to the logical address L5. However, the data storage device 100 will not perform an operation of storing the data DT1 in the storage area SA at the physical address P2.

In this case, as shown in FIG. 7, the data storage device 100 may update the address map MAP to reflect the new mapping relationship. Hence, according to the illustrated example, the mapping information MI showing the mapping relationship between the physical address P2 and the logical address L5 is generated, and the mapping number information MMI regarding the logical addresses mapped to the physical address P2 may be updated from “1” to “2.”

Hence, in a case where a second type write request W2 due to a file copy is received from the host, the data storage device 100 may process the write request only by updating the address map MAP even without actually having to write the data in a physical location, because the data is already present in at least one physical location.

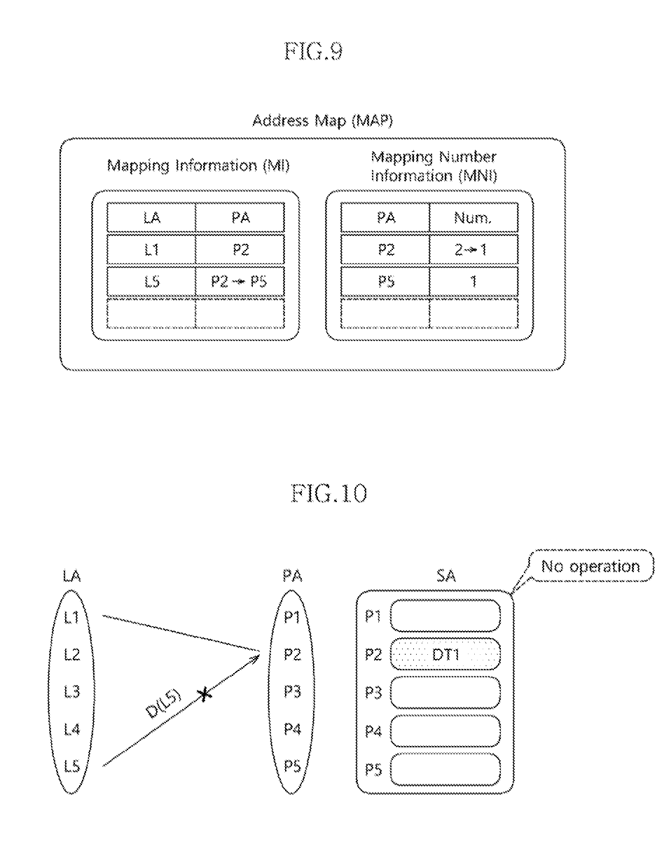

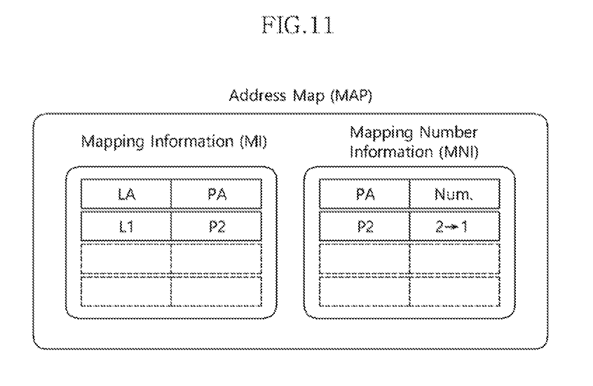

FIG. 8 illustrates a case where a write request due to a file change is transmitted to the data storage device 100. FIG. 9 is a diagram illustrating an example of an address map MAP of the data storage device 100 which processes the request illustrated in FIG. 8. For illustration purposes only, an example case wherein a first type write request W1 is transmitted due to change of the data DT1 of the file stored at the logical address L5 (i.e., the physical address P2) in response to a second type write request W2 (as described with reference to FIGS. 6 and 7) will be described with reference to FIGS. 8 and 9.

Accordingly, in a case where a file is changed by the file system, the host device 400 may transmit the first type write request. W1 to the data storage device 100. As shown in FIG. 8, the first type write request W1 may include as the request purpose information the request NEW due to a file change, the target logical address L5, and the write data DT2 of the changed file.

The data storage device 100 may determine based on the, transmitted write request W1(NEW/L5/DT2) that writing the data DT2 for the logical address L5 is requested and the, write request is due to a file change. Based on such a determination, the data storage device 100 may then map a physical address P5, which is not already mapped, to the logical address L5. Further, the data storage device 100 may store the data DT2 in the storage area SA corresponding to the physical address P5.

In this case, as shown in FIG. 9, the data storage device 100 may update the address map MAP to reflect the newly created mapping relationship. In other words, the mapping information MI showing the mapping relationship between the physical address P2 and the logical address L5 may be updated to show the mapping relationship between the physical address P5 and the logical address L5, the mapping number information MNI regarding the logical addresses mapped to the physical address P2 may be updated from “2” to “1,” and another mapping number information MNI showing the number (i.e., value of “1”) of logical addresses mapped to the physical address P5 may be generated.

In the case where the first type write request W1 due to a file change is received from the host, the data storage device 100 may process the first type write request W1 through updating the address map MAP and also actually storing the data DT2 in the storage area SA corresponding to the physical address P5.

FIG. 10 is a diagram illustrating a case where an erase request due to a file erase is transmitted to the data storage device 100, for example, from a host. FIG. 11 is a diagram illustrating an example of an address map MAP of the data storage device 100 which processes the request illustrated in FIG. 10. For illustration purposes only, an example case that an erase request D is transmitted due to an erase of the data DTI of the file stored at the logical address L5 (i.e., the physical address P2) in response to the second type write request W2 (as described with reference to FIGS. 6 and 7) will be described with reference to FIGS. 10 and 11.

In the case where the file is erased by the file system, the host device 400 may transmit the erase request D to the data storage device 100. As shown in FIG. 10, the erase request D may include the target logical address L5.

The data storage device 100 may determine based on the transmitted erase request D(L5) that erasing the data DT1 of the logical address L5 is requested. Based on such a determination, the data storage device 100 may then erase the mapping information MI showing the mapping relationship between the physical address P2 mapped and the logical address L5. However, the data storage device 100 will not perform an operation of erasing the data DT1 stored in the storage area SA corresponding to the physical address P2.

In this case, as shown in FIG. 11, the data storage device 100 may update the address map MAP to reflect the newly created mapping relationship. That is to say, the mapping information MI showing the mapping relationship between the physical address P2 and the logical address L5 may be erased from the mapping information MI, and the napping number information MNI regarding the logical addresses mapped to the physical address P2 may be updated from “2” to “1.”

In the case where the erase request 0 due to a file erase is transmitted to the data storage device, the data storage device 100 may process the erase request by updating the address map MAP only and without actually erasing any data.

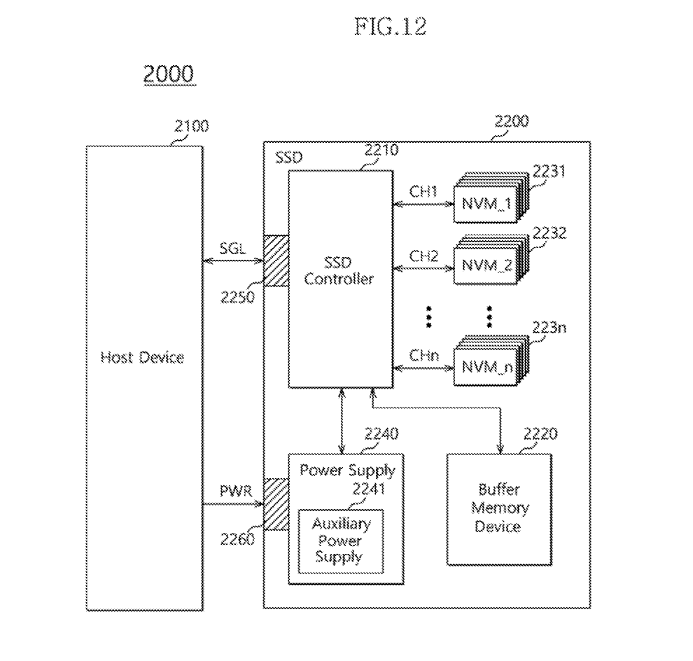

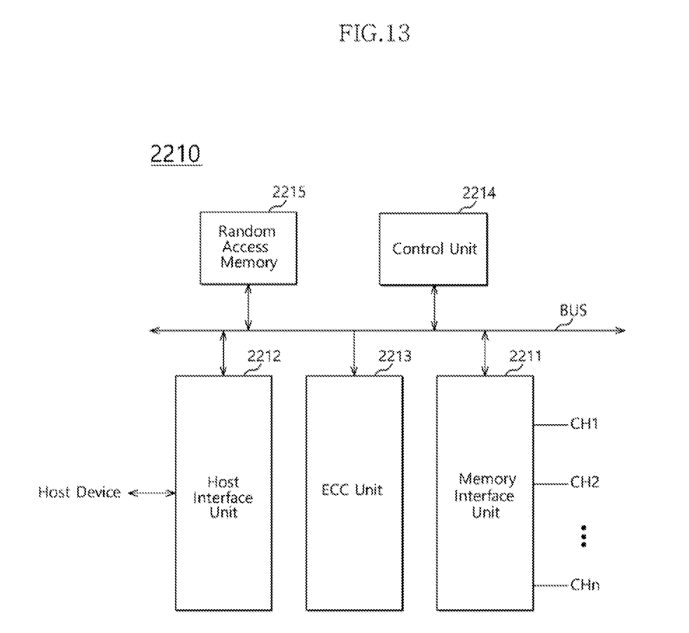

FIG. 12 is a block diagram illustrating a data processing system 2000, according to an embodiment of the invention. Referring to FIG. 12, a data processing system 2000 may include a host device 2100 and a solid state drive (SSD) 2200.

The SSD 2200 may include an SSD controller 2210, a buffer memory device 2220, nonvolatile memory devices 2231 to 223n, a power supply 2240, a signal connector 2250, and a power connector 2260.

The SSD controller 2210 may access the nonvolatile memory devices 2231 to 223n in response to a request from the host device 2100.

The buffer memory device 2220 may temporarily store data to be stored in the nonvolatile memory devices 2231 to 223n. Further, the buffer memory device 2220 may temporarily store data which are read out from the nonvolatile memory devices 2231 to 223n. The data which are temporarily stored in the buffer memory device 2220 nay be transmitted to the host device 2100 or the nonvolatile memory devices 2231 to 223n under the control of the SSD controller 2210, as may be needed.

The nonvolatile memory devices 2231 to 223n may be used as storage media of the SSD 2200. The nonvolatile memory devices 2231 to 223n may be coupled with the SSD controller 2210 through a plurality of channels CH1 to CHn, respectively. One or more nonvolatile memory devices may be coupled to one channel. The nonvolatile memory devices coupled to each channel may be coupled to the same signal bus and data bus.

The power supply 2240 may provide power PWR inputted through the power connector 2260, to the inside of the SSD 2200. The power supply 2240 may include an auxiliary power supply 2241. The auxiliary power supply 2241 may supply power to allow the SSD 2200 to he normally terminated when a sudden power-off occurs. The auxiliary power supply 2241 may include large capacitance capacitors capable of charging power PWR.

The SSD controller 2210 may exchange a signal SGL with the host device 2100 through the signal connector 2250. The signal SGL may include a command, an address, data, and the like. The signal connector 2250 may be configured by a connector, such as, for example, of parallel advanced technology attachment (PATA), serial advanced technology attachment (SATA), small computer system interface (SCSI), serial attached SCSI (SAS), peripheral component interconnection (PCI), PCI express (PCI-E) and universal flash storage (UFS) protocols, according to an interface scheme between the host device 2100 and the SSD 2200.

FIG. 13 is a block diagram illustrating an example of the SSD controller shown in FIG. 12. Referring to FIG. 13, the SSD controller 2210 may include a memory interface unit 2211, a host interface unit 2212, an error correction code (ECC) unit 2213, a control unit 2214, and a random access memory 2215, operatively coupled together through at least one communication bus BUS.

The memory interface unit 2211 may provide control signals, such as, for example, commands and addresses to the nonvolatile memory devices 2231 to 223n. Moreover, the memory interface unit 2211 may exchange data with the nonvolatile memory devices 2231 to 223n. The memory interface unit 2211 may scatter data transmitted from the buffer memory device 2220 to the respective channels CH1 to CHn, under control of the control unit 2214. Furthermore, the memory interface unit 2211 may transmit data read out from the nonvolatile memory devices 2231 to 223n to the buffer memory device 2220, under control of the control unit 2214.

The host interface unit 2212 may provide interfacing with respect to the SSD 2200 in correspondence to the protocol of the host device 2100. For example, the host interface unit 2212 may communicate with the host device 2100 through any one of a parallel advanced technology attachment (PATA), serial advanced technology attachment (SATA), small computer system interface (SCSI), serial attached SCSI (SAS), peripheral component interconnection (PCI), PCI express (PCI-E) and universal flash storage (UFS) protocols. In addition, the host interface unit 2212 may perform a disk emulating function of supporting the host device 2100 to recognize the SSD 2200 as a hard disk drive (HDD).

The control unit 2214 may analyze and process the signal SGL inputted from the host device 2100. The control unit 2214 may control operations of the buffer memory device 2220 and the nonvolatile memory devices 2231 to 223n according to a firmware or a software for driving the SSD 2200. The random access memory 2215 may be used as a working memory for driving the firmware or the software.

The control unit 2214 may perform an operation based on a request purpose included in a request transmitted from the host device 2100. For example, the control unit 2214 may process a write request only by changing an address map even without actually writing data, and may process an erase request only by updating the address map even without actually erasing data.

The error correction code (ECC) unit 2213 may generate parity data to be transmitted to the nonvolatile memory devices 2231 to 223n, among data stored in the buffer memory device 2220. The generated parity data may be stored, along with data, in the nonvolatile memory devices 2231 to 223n. The error correction code (ECC) unit 2213 may detect an error of the data read out from the nonvolatile memory devices 2231 to 223n. When the detected error is within a correctable range, the error correction code (ECC) unit 2213 may correct the detected error.

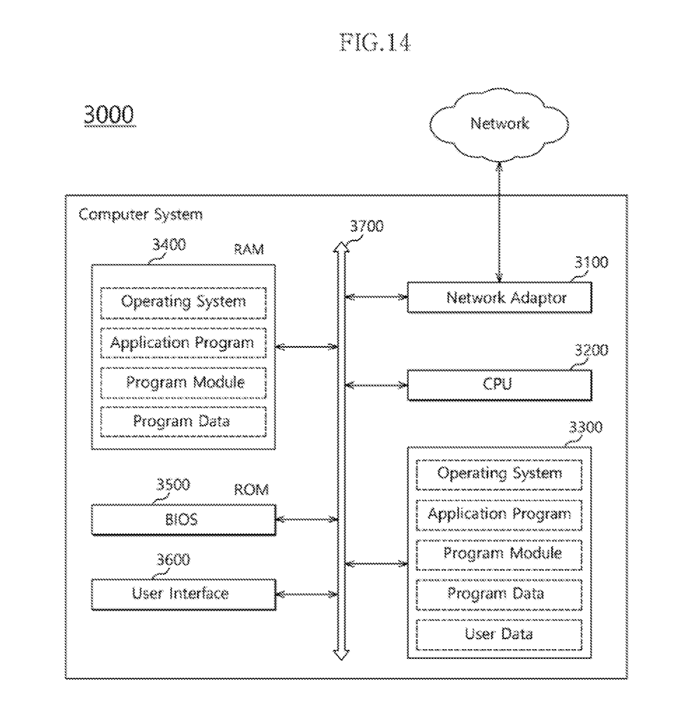

FIG. 14 illustrates a computer system including a data storage device mounted thereon, according to an embodiment of the present invention. According to the embodiment of FIG. 14, a computer system 3000 may include a network adaptor 3100, a central processing unit 3200, a data storage device 3300, a RAM 3400, a ROM 3500 and a user interface 3600, which are coupled electrically to a system bus 3700. The data storage device 3300 may be constructed by the data storage device 100 shown in FIG. 1 or the SSD 2200 shown in FIG. 12.

The network adaptor 3100 may provide interfacing between the computer system 3000 and external networks. The central processing unit 3200 may perform general calculation processing for driving an operating system residing at the RAM 3400 or an application program.

The data storage device 3300 may store general data needed in the computer system 3000. For example, an operating system for driving the computer system 3000, an application program, various program modules, program data and user data may be stored in the data storage device 3300.

The RAM 3400 may be used as the working memory of the computer system 3000. Upon booting, the operating system, the application program, the various program modules and the program data needed for driving programs, which are read out from the data storage device 3300, may be loaded in the RAM 3400. A BIOS (basic input/output system) which is activated before the operating system is driven may be stored in the ROM 3500. Information exchange between the computer system 3000 and a user may be implemented through the user interface 3600.

While various embodiments have been described above, it will be understood to those skilled in the art that the embodiments described are examples only. Accordingly, the data processing system including a data storage device described herein should not be limited based on the described embodiments.

We also note, that in some instances, as would be apparent to those skilled in the relevant art, a feature or element described in connection with one embodiment may be used singly or in combination with other features or elements of another embodiment, unless otherwise specifically indicated.

It will be apparent to those skilled in the art that various changes and modifications may be made without departing from the spirit and scope of the invention as defined in the following claims.

What is claimed is:

1. A data processing system comprising:
a data storage device; and
a host device suitable for transmitting a write request to the data storage device to store data in the data storage device,
wherein the host device transmits the write request including a request purpose information, and
wherein the data storage device processes the write request la based on the request purpose information.

2. The data processing system according to claim 1, wherein the request purpose information denotes whether the write request is due to a file generation, a file change, or a file copy.

3. The data processing system according to claim 2, wherein, when the write request is due to file generation or file change, the host device transmits the write request including the request purpose information, a logical address and data.

4. The data processing system according to claim 3, wherein the data storage device processes the write request by updating an address map and storing the data in a storage area.

5. The data processing system according to claim 4, wherein the data storage device updates the address map by generating a mapping information between a physical address, which is not mapped, to the logical address, and by generating a mapping number information denoting the number of logical addresses mapped to the physical address.

6. The data processing system according to claim 4, wherein the data storage device stores the data at the physical address in the storage area.

7. The data processing system according to claim 2,
wherein when the write request is due to file copy, the host device transmits the write request including the request purpose information, a target logical address indicating a storage area into which a copied data of the file is stored, and a source logical address, indicating a storage area from which a data of the file is copied.

8. The data processing system according to claim 7, wherein the data storage device processes the write request only by updating the address map for the logical address, without storing data.

9. The data processing system according to claim 8, wherein the data storage device updates the address map by generating a mapping information between a physical address, which is mapped to the source logical address, to the target logical address, and by updating a mapping number information of logical addresses mapped to the physical address.

10. The data processing system according to claim 1, wherein the host device additionally transmits an erase request including a logical address, to the data storage device, to erase data stored in the data storage device.

11. The data processing system according to claim 10, wherein the data storage device processes the erase request only by updating the address map for the logical address, without erasing data.

12. The data processing system according to claim 11, wherein the data storage device changes the address map by erasing a mapping information between a physical address and the logical address.

13. The data processing system according to claim 1, wherein the data storage device comprises at least one nonvolatile memory device as a storage medium.

14. A data processing system comprising:
a data storage device; and
a host device configured to transmit a write request according to a transmission protocol with respect to the data storage device, to the data storage device, to store data in the data storage device,
wherein the host device transmits the write request including a cause information representing which operation causes the write request, and
wherein the data storage device processes the write request based on the cause information,

15. The data processing system according to claim 14, wherein the cause information of the write request means whether the write request is due to generation of change of a file or copy of a file.

16. The data processing system according to claim 15, wherein the data storage device processes the write request by storing data in a storage area of a storage medium, based on the cause information meaning that the write request is due to generation or change of a file.

17. The data processing system according to claim 15, wherein the data storage device processes the write request only by changing an address map without storing data, based on the cause information meaning that the write request is due to copy of a file.
